(19) United States
(12) Patent Application Publication
(10) Pub. No.: US 2015/0094112 A1
(43) Pub. Date: Apr. 2, 2015

(54) Power Control to Compensate Interference Level Changes

(71) Applicant: Renesas Mobile Corporation, Tokyo (JP)

(72) Inventors: Karl Marko Juhani LAMPINEN, Oulu (FI); Arto Johannes LEHTI, Oulu (FI); Tao CHEN, Espoo (FI); Tuomas Tapio HILTUNEN, Tampere (FI)

(73) Assignee: Renesas Mobile Corporation, Tokyo (JP)

(21) Appl. No.: 14/038,910

(22) Filed: Sep. 27, 2013

(51) Int. Cl. H04W 52/24; H04W 52/32

(52) U.S. Cl. CPC H04W 52/244; H04W 52/325
USPC 455/522; 370/336

(57) ABSTRACT

A user equipment (UE) determines a first transmission power for a control channel using closed loop power control with a wireless network; and determines a second transmission power for the control channel. For transmission time intervals (TTIs) in which the UE is transmitting the control channel and also transmitting data on a data channel, the UE selects the second transmission power for transmitting the control channel. For TTIs in which the UE is transmitting the control channel but not also transmitting data on the data channel, the UE selects the first transmission power for transmitting the control channel. Three distinct embodiments are shown for these two transmission powers, and also quantitative data is shown that in a HSPA system this technique reduces inter-user interference at least at high SINR.

### TECHNICAL FIELD

The exemplary and non-limiting embodiments of this invention relate generally to wireless communication systems, methods, devices and computer programs, and more specifically relate to transmission power control at a user equipment (UE) transmitting on a control channel and also transmitting in a time-division multiplexing (TDM) mode on a data channel.

### BACKGROUND

The Third Generation Partnership Project (3GPP) has approved a new study item for further enhancing the uplink in the High Speed Packet Access (HSPA) radio protocol; see document RP-122019 by Ericsson entitled STUDY ON FURTHER EUL ENHANCEMENTS [3GPP TSG Meeting #58; Barcelona, Spain; 4-7 Dec. 2012]. Some issues to be studied include a) enabling high user bitrates in a mixed-traffic scenario, for example by a more efficient method of confining high rise over thermal (RoT) operation to a dedicated secondary carrier; and b) rate Adaptation to support improved power and rate control for high rates. RoT indicates the ratio between the total power received from wireless sources at a base station and the thermal noise, and is typically used as a measure of congestion in cellular networks.

High RoT values are needed for operation in environments having high signal to noise ratio (SINR) and high bitrates. Interference between mobile devices (inter-user-interference) is typically the dominating source of interference in high RoT scenarios. Inter-user-interference can of course be removed by time domain multiplexing (TDM) scheduling of the involved user equipments (UEs), and this solution is proposed for the uplink HSPA enhancements by document R2-130249 by Ericsson and ST Ericsson, entitled FURTHER EUL ENHANCEMENTS—DEDICATED SECONDARY CARRIER [3GPP TSG-RAN WG2 #81; St. Julian's, Malta; Jan. 28-Feb. 1, 2013].

Considering the whole transmission perspective rather than per-UE, scheduling different UEs in different transmission time intervals (TTIs) can cause rapid changes in the inter-user-interference levels from the perspective of each UE. This is not necessarily a problem for the payload data on the enhanced dedicated physical data channel (E-DPDCH) since that data is scheduled only during TTI which are experiencing favorable inter-user-interference. However, the fast uplink power control in HSPA maintains the SINR level of the dedicated physical control channel (DPCCH) which is transmitted in all TTIs. The closed loop power control could be enhanced to take into account the TDM scheduling.

FIG. 1 illustrates an example of two users in TDM mode transmitting E-DPDCH data subframes. The control is such that the DPCCH is always transmitted. User 1 and user 2 use different scrambling codes, and so more power being scheduled for user 1 results in more interference being generated for user 2. This is seen in the control channel SINR illustrated in the lower graph of FIG. 1, which assumes that the transmission power is static (no power control).

The closed loop power control in the uplink can react to the changes in the received SINR. In HSPA this power control is such that up or down ‘steps’ are requested by the base station at a maximum rate of once per slot. This causes a certain lag for correcting larger changes in received SINR. The subframe length of the E-DPDCH is 2 or 10 ms, which means that large SINR changes may happen frequently with TDM scheduling; this diminishes the ability of the power control to maintain a SINR target due to the power control being too slow.

The TDM scheduling has been implemented for example in HSPA downlink, and was also considered during the HSPA uplink studies; see for example section 7.1.2.3 of 3GPP TR 25.896 V6.0.0 (2004-03) entitled FEASIBILITY STUDY FOR ENHANCED UPLINK FOR UTRA FDD. Further background teachings relevant to the invention detailed below can be seen at the following documents:
TSGR1#5(99)881 by Alcatel, Nortel, and Philips, entitled TEXT PROPOSAL FOR SPECIFICATIONS 25.214 AND 25.231 ON POWER CONTROL IN COMPRESSED MODE [3GPP TSG RAN Working Group 1, meeting #6; Espoo, Finland; 13-16 Jul. 1999] which proposes larger power control step sizes on transmission gap boundaries for compressed mode.
R1-130609 by Ericsson and ST-Ericsson, entitled FURTHER CLARIFICATION OF POWER CONTROL IN COMPRESSED MODE [3GPP TSG-RAN WG1 Meeting #72; St Julian's, Malta; 28 Jan.-1 Feb. 2013] gives additional information on power control in compressed mode. Neither this nor document TSGR1#5(99)881 considers that the transmitter could autonomously take into account the change in inter-user-interference in the TDM scheduling of E-DPDCH channel.
Zhuo Cheng, HYBRID POWER CONTROL IN TIME DIVISION SCHEDULING WIDEBAND CODE DIVISION MULTIPLEX ACCESS [Master's thesis 2011, Department of Communication Systems, School of Information and Communication Technology, Royal Institute of Technology, Stockholm, Sweden; available at http ://kth.diva-portal.org/smash/get/diva2:508199/FULLTEXT01] studies the power control problem in TDM scheduled HSPA uplink, and proposes using different power control algorithms for scheduled and non-scheduled TTIs, but it relies on using received signal code power (RSCP) which does not reflect quality of the signal.
R1-133667 by Ericsson, ST-Ericsson, entitled CPC AND POWER CONTROL CONSIDERATIONS FOR CLEAN CARRIERS [3GPP TSG RAN WG1 Meeting #74; Barcelona, Spain, 19-23 Aug. 2013] discuss TDM scheduling and power control but in a multi carrier context where the power control is maintained on a different carrier than the TDM scheduled data.

Embodiments of these teachings address the above lagging power control issue.

### SUMMARY

In a first exemplary aspect of the invention there is a method for operating a user equipment, the method comprising:
determining a first transmission power for a control channel using closed loop power control with a wireless network;
determining a second transmission power for the control channel;
selecting the second transmission power for the user equipment to transmit the control channel in transmission time intervals in which the user equipment is also transmitting data on a data channel; and
selecting the first transmission power for the user equipment to transmit the control channel in transmission time intervals in which the user equipment is not also transmitting data on the data channel.

In a second exemplary aspect of the invention there is an apparatus for operating a user equipment, where the apparatus comprises at least one processor and at least one memory storing a computer program. Together the at least one processor and the at least one memory storing the computer program may be considered as a processing system, though the apparatus may in other instances be an entire user equipment that hosts the processor and memory. In this aspect the at least one memory with the computer program is configured with the at least one processor to cause the apparatus to at least:
determine a first transmission power for a control channel using closed loop power control with a wireless network;
determine a second transmission power for the control channel;
select the second transmission power for the user equipment to transmit the control channel in transmission time intervals in which the user equipment is also transmitting data on a data channel; and
select the first transmission power for the user equipment to transmit the control channel in transmission time intervals in which the user equipment is not also transmitting data on the data channel.

In a third exemplary aspect of the invention there is a computer readable memory storing a computer program for operating a user equipment, wherein the computer program is executable by at least one processor and the computer program comprises:
code for determining a first transmission power for a control channel using closed loop power control with a wireless network;
code for determining a second transmission power for the control channel;
code for selecting the second transmission power for the user equipment to transmit the control channel in transmission time intervals in which the user equipment is also transmitting data on a data channel; and
code for selecting the first transmission power for the user equipment to transmit the control channel in transmission time intervals in which the user equipment is not also transmitting data on the data channel.

In a fourth exemplary aspect of the invention there is an apparatus comprising determining means and selecting means. The determining means is for determining a first transmission power for a control channel using closed loop power control with a wireless network, and for determining a second transmission power for the control channel. The selecting means is for selecting the second transmission power for the user equipment to transmit the control channel in transmission time intervals in which the user equipment is also transmitting data on a data channel; and for selecting the first transmission power for the user equipment to transmit the control channel in transmission time intervals in which the user equipment is not also transmitting data on the data channel. In one example the apparatus also has radio means for transmitting the control channel at the selected power.

As an example for the fourth aspect, both the determining means and the selecting means may be implemented as one or more processors operating an executable computer program that is stored on a local memory of a user equipment, and the radio means may be implemented as a transceiver or at least as a radio transmitter.

These and other embodiments and aspects are detailed below with particularity.

### BRIEF DESCRIPTION OF THE DRAWINGS:

FIG. 1 illustrates graphically transmissions by two users operating in time division multiplex mode, where the upper graph shows data and control channel transmissions and the lower graph shows inter-user-interference (assuming no power control).

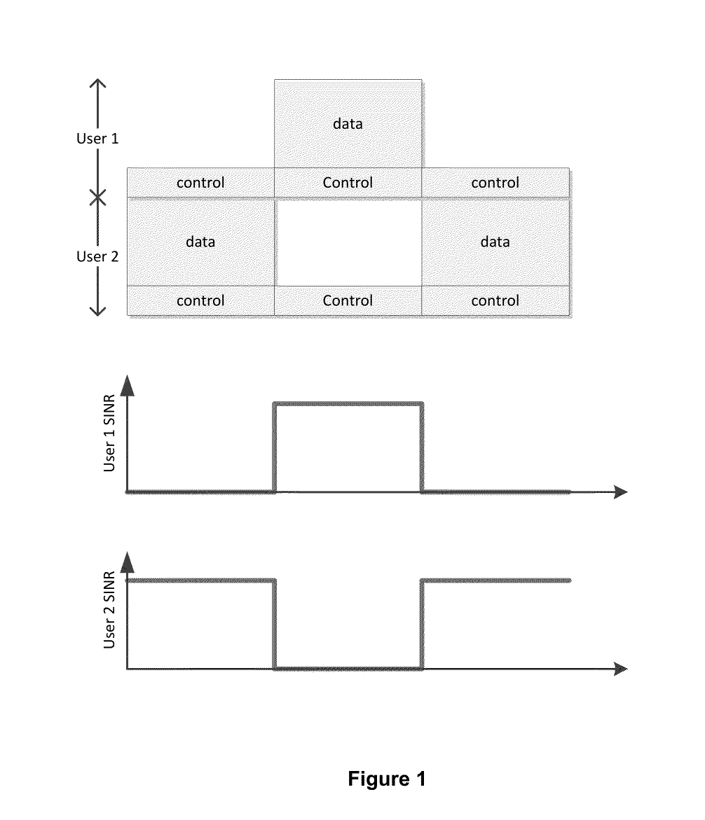

FIG. 2 is a timing diagram for uplink and downlink and showing a two-slot delay after the start of the UE's scheduled uplink data transmission for when the network base station/access node generates a power step Δ_{PC,own}_{ₜᵣₐₙₛₘᵢₛₛᵢₒₙ} command for the UE according to a second embodiment of these teachings.

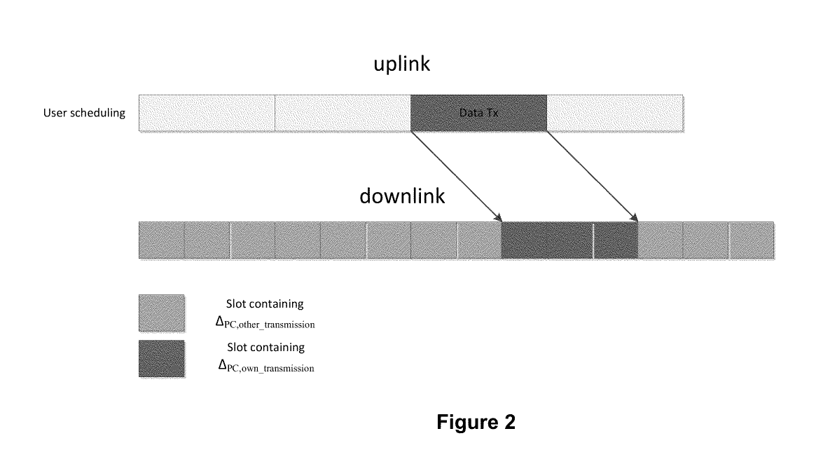

FIG. 3 is also a timing diagram but illustrating how a delta value for adjusting transmission power for the PDCCH is derived from conventional transmission power control commands the UE receives from the network, according to one implementation of a third embodiment of these teachings.

FIGS. 4-6 are data plots of SINR on the DPCCH for two different users, one using conventional HSPA transmission power control and one using enhanced power control according to a first embodiment of the invention detailed below, and these data plots quantify improvements of that first embodiment over the conventional HSPA approach.

FIG. 7 is a logic flow diagram that illustrates the operation of a method, and a result of execution of computer program instructions embodied on a computer readable memory, in accordance with certain exemplary embodiments of the invention.

FIG. 8 is a simplified block diagram showing examples of electronic devices that are suitable for use in practicing the exemplary embodiments of the invention.

### DETAILED DESCRIPTION

An improvement to the transmission power control can be designed in order to take into account the TDM scheduled data. As detailed in the background section, power control in conventional HSPA is too slow to react to TDM scheduling. Therefore it may be beneficial to prevent the reaction.

The compressed mode power control problem is similar to the TDM power control problem due to the gaps in transmission causing possibly rapid changes in signal quality. While this was also reviewed in the reference by Zhou Cheng cited in the background section, the Cheng solution uses different power control algorithms for scheduled and non-scheduled TTIs and switches between SINR and RSCP based power control. But as noted above, one drawback in using RSCP is that it does not reflect quality of the signal. A better solution can be achieved by modifying also the transmission power setting at the UE.

It is reasonable to assume that the UE is aware when to transmit the TDM scheduled subframe. This information can be used autonomously by the UE to change the DPCCH transmission power. Below are detailed three main embodiments for how this UE-autonomous power control can be put into effect.

To more comprehensively explain these three embodiments below, assume that the transmission power of the uplink DPCCH equals Pₜₓ (in dBm) and a fast power control step received by the UE equals Apc. Typically the power control step size is +/−1 dB but this is of course only an example and not limiting to the broader teachings herein. From this it follows that for a conventional 3GPP HSPA system, the transmission power of the DPCCH for the current slot equals P_{tx,DPCCH}=P_{tx,DPCCH}_{_{—}}_{old}+Δ_{PC}, where the P_{tx,DPCCH}_{_{—}}_{old} equals the transmission power in the previous slot.

In a first embodiment, the UE adds an additional power control step into the received power control command; that is, whatever is the power control command that the UE receives from the network/base station the UE can add an incremental step down (or a step up) to the value of that power control command. The power control step size increment is a predetermined value. Therefore, when the UE starts transmitting a TDM frame it can reduce the DPCCH power level since inter-user-interference is reduced. Similarly, after stopping transmission of TDM frames, the DPCCH power level can be slightly increased since it is likely that the inter-user-interference is increased, at least from the perspective of a single UE.

Using the above assumptions, for this first embodiment the transmission power of the DPCCH for the current slot equals P_{tx,DPCCH}=P_{tx,DPCCH}_{_{—}}_{old}+Δ_{PC}+Δ_{TDM}. Considering Δ_{TDM}, if |P_{prev-grant}−P_{current-grant}|α

Δ_{TDM}=Δₛₜₑₚsign(P_{prev-grant}−P_{current-grant})

otherwise

Δ_{TDM}=0

where
P_{prev-grant} equals the granted E-DPDCH transmission power in the previous subframe taking into account possible fast TDM scheduling of the subframes (for example, power is assumed to be zero if no data is transmitted despite the allowed high transmission power).
P_{current-grant} equals the granted E-DPDCH transmission power in the current subframe taking into account possible fast TDM scheduling of the subframes (again, power is assumed to be zero if no data is transmitted despite the allowed high transmission power).
α equals a threshold that the grant difference must exceed
Δₛₜₑₚ equals applied step size on the DPCCH transmission power. E.g. 2.0 dB
Sign(X) equals sign of X. e.g. sign(−5)=−1, sign(15)=1

In a second embodiment the UE maintains two separate transmission power levels for the DPCCH, one level for the TTIs in which the UE is transmitting E-DPDCH data and another level for the TTIs which are scheduled for other UEs. Power control for these two cases could then operate as it does in conventional HSPA, except the UE would need to determine which power control command is based on which transmission power and update the corresponding power. The UE can make this determination based on timing of the power control command.

In this case the changes in DPCCH power level would be sufficient since closed loop power control impacts the DPCCH, and in conventional HSPA the transmit power of other channels such as the E-DPCCH and E-DPDCH is derived from the transmit power on the DPCCH according to known scaling factors. Furthermore, no additional signaling is required for this second embodiment since the UE still receives power control commands and data scheduling commands.

For this second embodiment, the UE power control operates on power control commands as in the conventional HSPA system except there are two maintained transmission power levels as follows:
if the UE is transmitting E-DPDCH data in a TTI, the UE uses P_{tx,DPCCH,own}_{_{—}}ₜᵣₐₙₛₘᵢₛₛᵢₒₙ;
otherwise it uses P_{tx,DPCCH,others}_{_{—}}ₜᵣₐₙₛₘᵢₛₛᵢₒₙ.

These two power levels are maintained by power control commands

P_{tx,DPCCH,own}_{_{—}}ₜᵣₐₙₛₘᵢₛₛᵢₒₙ=P_{tx,DPCCH}_{_{—}}_{old,own}_{_{—}}ₜᵣₐₙₛₘᵢₛₛᵢₒₙ+Δ_{PC,own}_{_{—}}ₜᵣₐₙₛₘᵢₛₛᵢₒₙ

and

P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC,others}_{_{—}}ₜᵣₐₙₛₘᵢₛₛᵢₒₙ

where
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ equal transmission power of DPCCH for the current slot Final selection as to which power level to use in the transmisison depends on the scheduling decision,
P_{tx,DPCCH}_{_{—}}_{old,own}_{_{—}}ₜᵣₐₙₛₘᵢₛₛᵢₒₙ equals transmission power of DPCCH in the previous slot belonging to TTI where UE was transmitting E-DPDCH data, and
P_{tx,DPCCH}_{_{—}}_{old,others}_{_{—}}ₜᵣₐₙₛₘᵢₛₛᵢₒₙ equal transmission power of DPCCH in the previous slot belonging to TTI where UE was not transmitting E-DPDCH data.

In order to avoid the two power levels drifting too far away from each other, in one implementation there is defined a maximum power level difference such as Δ_{P,tx}=abs(P_{tx,DPCCH,own}_{_{—}}ₜᵣₐₙₛₘᵢₛₛᵢₒₙ−P_{tx,DPCCH,others}_{_{—}}ₜᵣₐₙₛₘᵢₛₛᵢₒₙ). If Δ_{P,tx} is exceeding a threshold value Δ_{P,max} then the power control command could affect both power levels.

There are various methods for transmitting in the downlink the power control step Δ_{PC,own}_{_{—}}ₜᵣₐₙₛₘᵢₛₛᵢₒₙ and Δ_{PC,others}_{_{—}}ₜᵣₐₙₛₘᵢₛₛᵢₒₙ. Currently the power control commands are carried by the transmission power control (TPC) field on either the fractional dedicated physical channel (F-DPCH) or the dedicated physical channel (DPCH). In HSPA each TPC command instructs the UE to step up or step down its transmission power by 1 dB. Different resources on the physical downlink channel (such as the F-DPCH or the DPCH) can be allocated to the two different commands. Different resources could be either allocating different spreading codes or allocating different slots on the same code. This may be inefficient for the case in which scheduled data is served infrequently, leaving some of the resources reserved but not used.

An alternative to the above different resources allocating the different power control commands is to time multiplex the commands together on the same resource, such as the F-DPCH or the DPCH TPC field, depending on the uplink scheduling decisions. If an uplink E-DPDCH subframe is scheduled, the base station/nodeB generates the power step Δ_{PC,own}_{_{—}}ₜᵣₐₙₛₘᵢₛₛᵢₒₙ commands after a specified delay or after a delay configured by higher layers. If no data is scheduled, the power step command Δ_{PC,others}_{_{—}}ₜᵣₐₙₛₘᵢₛₛᵢₒₙ is transmitted.

This is illustrated in Error! Reference source not found. which illustrates power control command timing. The UE is scheduled for uplink data transmission at the darkly shaded section of the uplink row (upper row), and so the base station starts generating the power step Δ_{PC,own}_{_{—}}ₜᵣₐₙₛₘᵢₛₛᵢₒₙ commands after the start of the UE's scheduled uplink data transmission and continues to generate these commands until the allocation to the specific UE ends. The figure takes into account a processing delay for the power control loop. In this example the delay of two slots is either the specified delay, or the delay configured by higher layers. When data is not scheduled for the UE Δ_{PC,others}_{_{—}}ₜᵣₐₙₛₘᵢₛₛᵢₒₙ commands are transmitted.

In the third embodiment the UE power control operates as it does in conventional HSPA, except that during the TTIs in which the UE is transmitting E-DCH data the UE reduces its transmission power of the DPCCH by a delta value, where for example this delta value can be configured by higher layers such as the radio resource control (RRC) layer. The delta value needs to be chosen so that it is as close as possible to the interference variation between the TTIs where the UE is transmitting itself and the TTIs where other UEs are transmitting. Outer loop power control can then address any additional power variations.

In this third embodiment, the UE power control operates on power control commands as in the conventional HSPA system. DPCCH transmission power is reduced by delta in those TTIs where the UE is transmitting E-DCH data as follows:
if the UE is transmitting E-DPDCH data in a TTI, P_{tx,DPCCH,own}_{_{—}}ₜᵣₐₙₛₘᵢₛₛᵢₒₙ is used;
otherwise P_{tx,DPCCH,others}_{_{—}}ₜᵣₐₙₛₘᵢₛₛᵢₒₙ is used.

These two power levels are maintained by power control commands

P_{tx,DPCCH,own}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ−Δ_{own}_{_{—}}ₜᵣₐₙₛₘᵢₛₛᵢₒₙ+Δ_{PC}

and

P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC}

where
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ equal transmission power of the DPCCH for the current slot. Final selection as to which power level to use in the transmisison depends on the scheduling decision.
P_{tx,DPCCH}_{_{—}}_{old,others}_{_{—}}ₜᵣₐₙₛₘᵢₛₛᵢₒₙ equals transmission power of the DPCCH in the previous slot belonging to the TTI where the UE was not transmitting E-DPDCH data.
Δ_{own}_{_{—}}ₜᵣₐₙₛₘᵢₛₛᵢₒₙ is the difference in how much transmission power can be lower for TTIs with the UE's own E-DCH transmission.

In one variation of the third embodiment the delta value itself is derived from the received TPC commands, which are issued based on the latest own-data transmission period. In this case, any power control delay (lag) should be taken into account. If for example there is a large difference on the interference between a UE's own and other UE's data transmissions, the received TPC commands can reflect such difference and accordingly are used for the delta calculation.

The power step Δ_{own}_{_{—}}ₜᵣₐₙₛₘᵢₛₛᵢₒₙ in this variation of the third embodiment is derived based on the received TPC commands, which are issued based on the latest own data transmission period.

Δ_{own}_{_{—}}ₜᵣₐₙₛₘᵢₛₛᵢₒₙ=Δ_{own}_{_{—}}ₜᵣₐₙₛₘᵢₛₛᵢₒₙ+offset

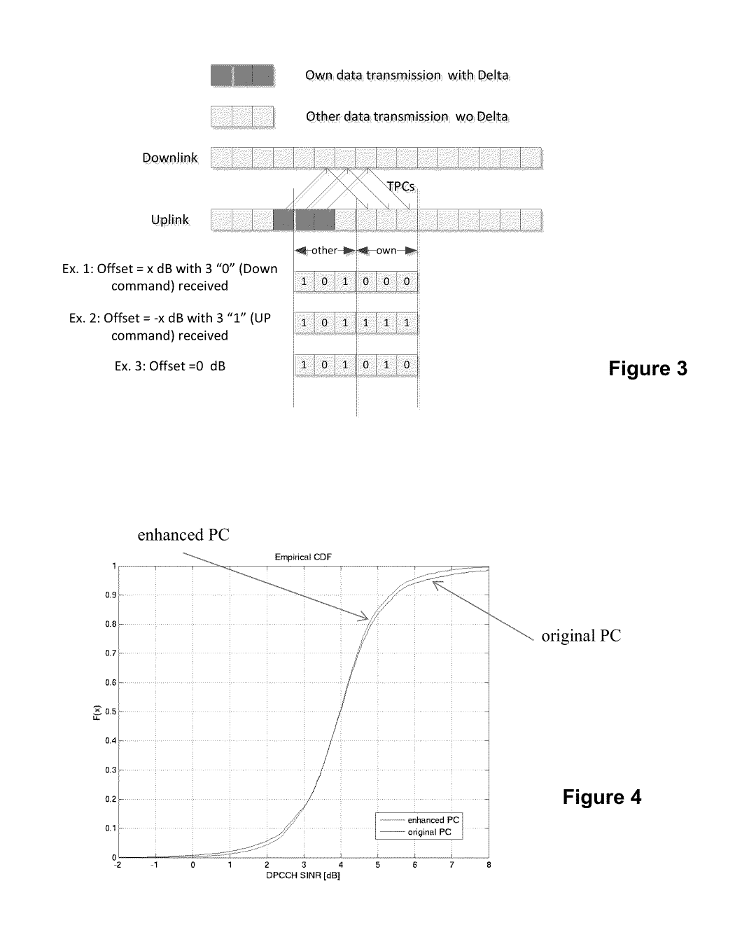

As an example, assume a 2 ms TTI with 3 slots. Then as shown in FIG. 3:
For example 1, the offset=x dB, if the UE receives 3 consecutive “DOWN” commands issued based on the latest data transmission in one TTI.
For example 2, the offset=−x dB, if UE receives 3 consecutive “UP” commands issued based on the latest data transmission in one TTI.
Otherwise, Offset=0 dB.

Alternatively, the offset can be set according to the relative changes of TPC commands issued with and without a data transmission. For example:
Offset=x dB, if DOWN_OwnTTI−DOWN_OtherTTI>3;
Offset=−x dB, if UP_OwnTTI−UP_OtherTTI>3;
Otherwise, Offset=OdB.
where:
   DOWN(UP)_OwnTTI means the total number of DOWN(UP) commands received corresponding to the latest own data transmission in one TTI, and
   DOWN(UP)_OtherTTI means the total number of DOWN(UP) commands received corresponding to the latest other UE data transmission in one TTI, and
   the value x can be defined by the UE or signaled by the base station.

For any of the embodiments above, an additional aspect can be added for the case in which the TDM scheduling is transparent to the UE. Specifically, a common or UE specific signaling can be introduced for the base station to instruct the UE (or all UEs if common signaling) whether the new power control schemes of the embodiments set forth above are allowed in the cell. Since it is possible that the UE may not be aware of whether the network is using TDM scheduling, then this additional signaling by the base station can assist the UE to know when to use the above new power control schemes properly. For example, this can be implemented by introducing a new channel that shares the same channel structure as the enhanced relative grant channel (E-RGCH), and carrying 1 bit which can be used to switch on and switch off the above new power control schemes.

Further, in another implementation that can also be used in conjunction with the above base station signaling, some threshold parameters used in these new power control schemes can be controlled by the base station/eNB via layer 1 (L1) or via layer 3 (L3) signaling.

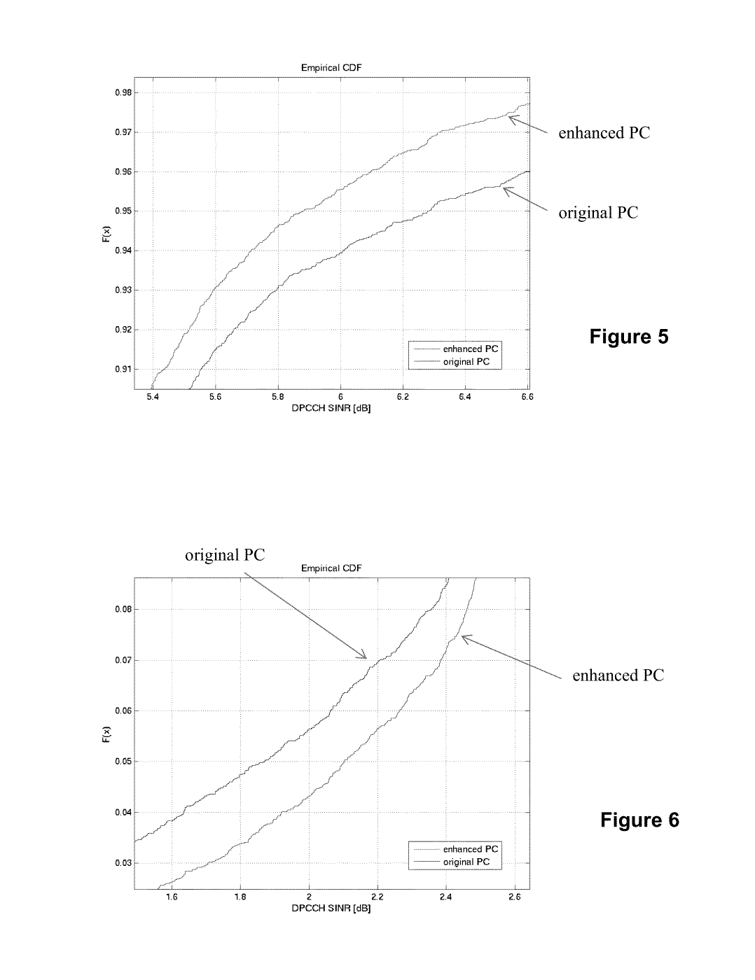

FIGS. 4-6 are graphs of SINR on the DPCCH and which quantify advantages that certain of the above teachings can provide in reducing inter-user-interference in the DPCCH. These Figures show DPCCH SINR in a two user TDM system where current power control algorithm is compared to the first embodiment of the invention detailed above, labeled in those Figures as ‘original PC’ for the conventional HSPA power control and ‘enhanced PC’ for the power control according to first embodiment of these teachings. For all three graphs the applied step size was 2 dB. The variance of DPCCH SINR is reduced from 1.9 to 1.4 as can be seen also from FIGS. 3 and 4. The probability of the extreme SINR values is reduced. FIGS. 5 and 6 illustrate respectively the 95^{th} and the 5^{th} percentile of the DPCCH SINR cumulative distribution function (CDF).

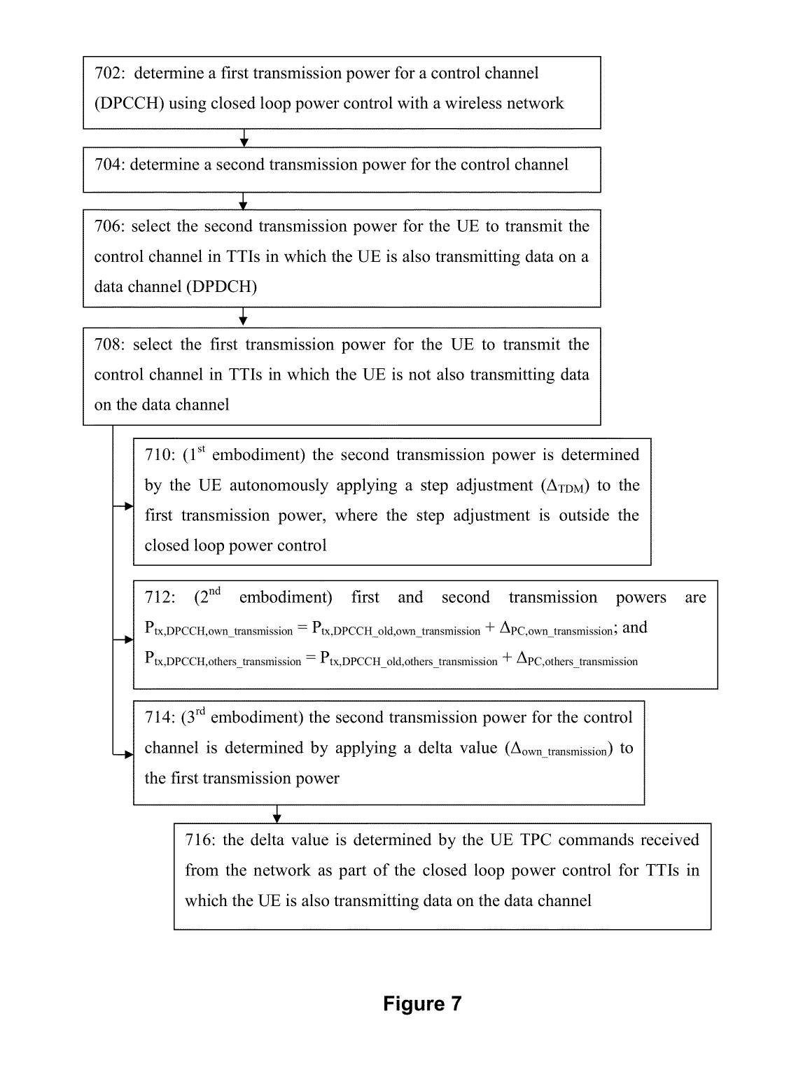

FIG. 7 summarizes some of the above teachings, and is a logic flow diagram which describes an exemplary embodiment for operating a user equipment (UE), and presented from the perspective of the UE. FIG. 7 represents results from executing a computer program or an implementing algorithm stored in the local memory of the UE, as well as illustrating the operation of a method and a specific manner in which one or more components of a UE or intended for incorporation into a UE are configured to cause that host UE device to operate. The various blocks shown in FIG. 7 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Blocks 702, 704, 706 and 708 of FIG. 7 present a generalized concept of power control according to embodiments of these teachings, while blocks 710, 712, 714 and 716 provide details that are more specific to some of the individual embodiments that are detailed above in further detail. At block 702 the UE determines a first transmission power for a control channel using closed loop power control with a wireless network. In the above examples that control channel was the DPCCH. At block 704 the UE determines a second transmission power for the control channel. The UE selects at block 706 the second transmission power for the UE to transmit the control channel in TTIs in which the UE is also transmitting data on a data channel; and selects at block 708 the first transmission power for transmitting the control channel in TTIs in which the UE is not also transmitting data on the data channel.

Note that the TTIs in which the first transmission power applies, where the UE operating according to FIG. 7 is transmitting the control channel DPCCH but not also transmitting the data channel DPDCH, does not imply that the network or the DPDCH is idle or otherwise not in active use during that time. It is assumed that there may be other UEs transmitting on the DPDCH in those TTIs, in fact this is the situation where the improvement to inter-user-interference is most manifest. But FIG. 7 is from the perspective of one UE, and that UE may not have knowledge of the specific TTIs in which any other nearby UE in the cell may be scheduled to transmit data on the DPDCH. For that reason blocks 708 and 710 characterize the different TTIs only as those in which the UE following FIG. 7 is transmitting control (DPCCH) and data (DPDCH), or only control (DPCCH); rather than activity of other UEs in those TTIs. This one-UE perspective carries through to block 712; the transmit powers for the ‘others_transmission” are for those TTIs in which other UEs may be transmitting data on the DPDCH. Whether a given TTI falls within the TTIs identified at block 706 or the TTIs identified at block 708 does not depend on any DPDCH transmission, or lack thereof, by any other UE.

Block 710 of FIG. 7 summarizes the first embodiment detailed above; the second transmission power is determined by the UE autonomously, by applying a step adjustment to the first transmission power. Since it is autonomous by the UE that step adjustment is outside the closed loop power control noted in block 702.

As detailed above more particularly, for the first embodiment the first transmission power is P_{tx,DPCCH}=P_{tx,DPCCH}_{_{—}}_{old}+Δ_{PC}, where P_{tx,DPCCH}_{_{—}}_{old} is the user equipment's transmission power for the control channel in a previous slot and Δ_{PC} is a power control step received from the wireless network; and the second transmission power is P_{tx,DPCCH}=P_{tx,DPCCH}_{_{—}}_{old}+Δ_{PC}+Δ_{TDM}, where the step adjustment is Δ_{TDM} and a sign of the step adjustment Δ_{TDM} is given by sign(P_{prev-grant}−P_{current-grant}) in which P_{prev-grant} and P_{current-grant} are transmission powers granted to the user equipment for the data channel in a previous and in a current slot respectively. In this case the magnitude of the step adjustment Δ_{TDM} is predefined in a radio standard, or in wireless signaling received from the wireless network. Also as detailed above, applying the step adjustment is contingent on |P_{prev-grant}−P_{current-grant}| being greater than a predefined threshold α.

Block 712 of FIG. 7 summarizes the second embodiment detailed above; the first transmission power is P_{tx,DPCCH,own}_{_{—}}ₜᵣₐₙₛₘᵢₛₛᵢₒₙ=P_{tx,DPCCH}_{_{—}}_{old,own}_{_{—}}ₜᵣₐₙₛₘᵢₛₛᵢₒₙ+Δ_{PC,own}_{_{—}}ₜᵣₐₙₛₘᵢₛₛᵢₒₙ; and the second transmission power is P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC,others}_{_{—}}ₜᵣₐₙₛₘᵢₛₛᵢₒₙ. These parameters are defined above as follows:
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot where the user equipment is and is not also transmitting data on the data channel, respectively;
P_{tx,DPCCH}_{_{—}}_{old,own}_{_{—}}ₜᵣₐₙₛₘᵢₛₛᵢₒₙ is transmission power of the control channel in a previous slot belonging to a transmission time interval in which the user equipment was also transmitting data on the data channel;
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel; and
Δ_{PC,own}_{_{—}}ₜᵣₐₙₛₘᵢₛₛᵢₒₙ and Δ_{PC,others}_{_{—}}ₜᵣₐₙₛₘᵢₛₛᵢₒₙ are power control steps received from the wireless network corresponding to slots where the user equipment is and is not also transmitting data on the data channel, respectively.

Block 714 of FIG. 7 summarizes the third embodiment detailed above; the second transmission power for the control channel is determined by applying a delta value to the first transmission power. More specifically, the detailed but non-limiting example above provided that the first transmission power is P_{tx,DPCCH,others}_{_{—}}ₜᵣₐₙₛₘᵢₛₛᵢₒₙ=
P_{tx,DPCCH}_{_{—}}_{old,others}_{_{—}}ₜᵣₐₙₛₘᵢₛₛᵢₒₙ+Δ_{pc}, and the second transmission power is P_{tx,DPCCH,own}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ−Δ_{own}_{_{—}}ₜᵣₐₙₛₘᵢₛₛᵢₒₙ+Δ_{PC}. These parameters were defined above as follows:
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot;
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel; and
Δ_{own}_{_{—}}ₜᵣₐₙₛₘᵢₛₛᵢₒₙ is the delta value.

Block 716 of FIG. 7 summarizes one implementation for the third embodiment, namely that the delta value is determined by the UE using transmission power control commands that are received from the network as part of the closed loop power control for TTIs in which the UE is also transmitting data on the data channel.

Not shown at FIG. 7 but noted above is that the power control according to these teachings, that is, execution by a UE of the process shown at FIG. 7, is contingent upon the UE receiving an explicit indication from the wireless network that TDM is currently in use for scheduling the UE. This signaling can be common signaling (such as over a broadcast channel) or UE-specific signaling, and is useful in some deployments since the UE may not know whether or not the network is scheduling using TDM.

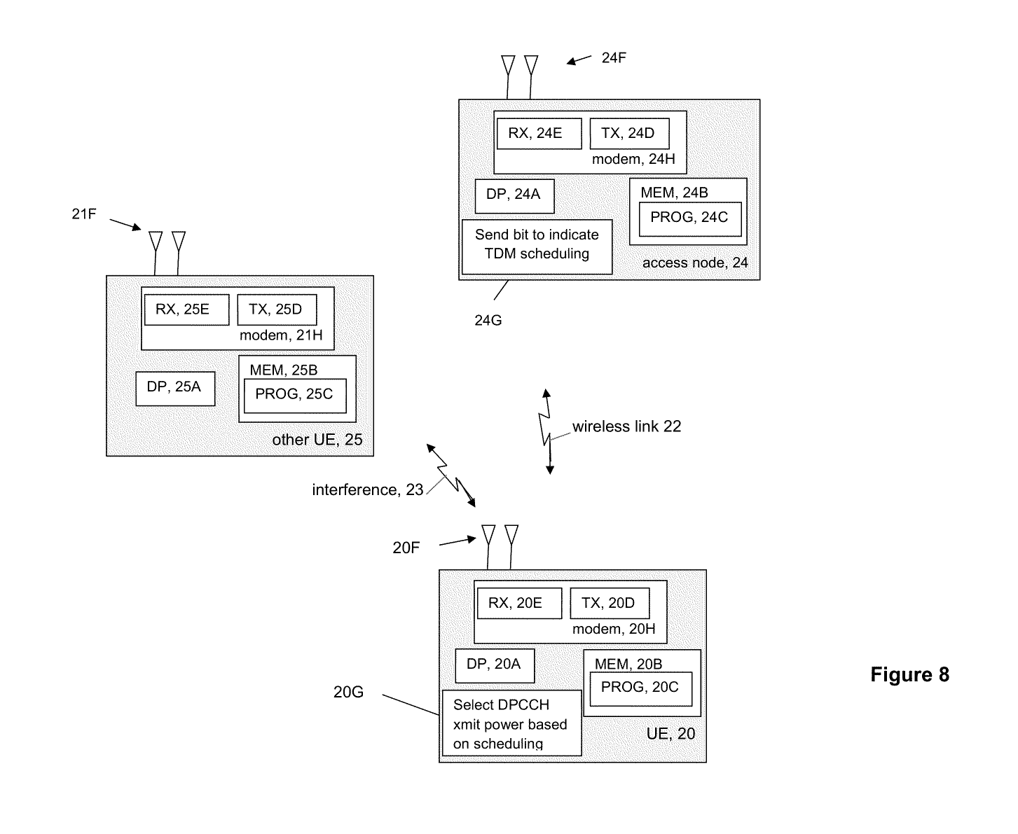

Reference is now made to FIG. 8 for illustrating a simplified block diagram of various electronic devices and apparatus that are suitable for use in practicing the exemplary embodiments of this invention. In FIG. 8 there is a network access node 24 such as a node B, an e-node B, a base station, a remote radio head, a relay station and the like, that is adapted for communication over a wireless link 22 with a mobile device/UE 20.

In one particular implementation, the user device/UE 20 may be embodied as a mobile handset such as a smartphone, or a wearable radio, or a vehicle mounted radio, and the like. The UE 20 includes processing means such as at least one data processor (DP) 20A, storing means such as at least one computer-readable memory (MEM) 20B storing at least one computer program (PROG) 20C, and also communicating means such as a transmitter TX 20D and a receiver RX 20E for bidirectional wireless communications with the network access node 24 via one or more antennas 20F. The RX 20E and the TX 20D are each shown as being embodied with a modem 20H in a radio-frequency front end chip, which is one non-limiting embodiment; the modem 20H may be a physically separate but electrically coupled component. The UE 20 also has stored in the MEM 20B at block 20G computer program code for selecting a first or a second transmission power for transmitting a control channel, where the selection is dependent on whether of not the UE is transmitting the control channel in the same TTI as it is transmitting data on a data channel as detailed above by the various examples and implementation.

There is also shown an other UE 25 that similarly includes processing means such as at least one data processor (DP) 25A, storing means such as at least one computer-readable memory (MEM) 25B storing at least one computer program (PROG) 25C, and communicating means such as a transmitter TX 25D and a receiver RX 25E and a modem 25H for bidirectional wireless communications with the access node 24 via one or more antennas 21F. The other UE 25 is subject to inter-user-interference 23 from the first-introduced UE 20, which is reduced according to embodiments and implementations of these teachings. The other UE 25 may or may not also have a computer program to implement these teachings so as to reduce its own inter-user-interference with the first-introduced UE 20.

The network access node 24 includes its own processing means such as at least one data processor (DP) 24A, storing means such as at least one computer-readable memory (MEM) 24B storing at least one computer program (PROG) 24C, and communicating means such as a transmitter TX 24D and a receiver RX 24E and a modem 24H for bidirectional wireless communications with UE 20 detailed above via its antennas 24F. The network access node 24 stores at block 24G in its local MEM 24B a computer program for sending at least one bit (via UE-specific or common signaling) to indicate to the UE 20 that TDM scheduling is in use in the cell, and thus indicating that the UE 20 should use the inter-user-interference power control teachings described herein and implemented by the UE's computer program 20G. The network access node 24 may also have stored in its own memory 24B another computer program similar to that described at 20G for the UE 20 so the network access node 24 can properly track the UE's transmit power on the DPCCH or other relevant control channel.

At least one of the PROGs 20C, 24C, in the respective device 20, 24, is assumed to include program instructions that, when executed by the associated DP 20A, 24A, enable the device to operate in accordance with the exemplary embodiments of this invention, as detailed above. Blocks 20G and 24G summarize different results from executing different tangibly stored software to implement certain aspects of these teachings. In these regards the exemplary embodiments of this invention may be implemented at least in part by computer software stored on the MEM 20B, 24B, which is executable by the DP 20A of the UE 20 and/or by the DP 24A of the network access node 24, or by hardware, or by a combination of tangibly stored software and hardware (and tangibly stored firmware). Electronic devices implementing these aspects of the invention need not be the entire devices as depicted at FIG. 8, but exemplary embodiments may be implemented by one or more components of same such as the above described tangibly stored software, hardware, firmware and DP, or a system on a chip SOC or an application specific integrated circuit ASIC.

Various embodiments of the computer readable MEMs 20B, 24B, 25B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 24A, 25A include but are not limited to general purpose computers, special purpose computers, microprocessors, digital signal processors (DSPs) and multi-core processors.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

What is claimed is:

1. A method for operating a user equipment, the method comprising:
determining a first transmission power for a control channel using closed loop power control with a wireless network;
determining a second transmission power for the control channel;
selecting the second transmission power for the user equipment to transmit the control channel in transmission time intervals in which the user equipment is also transmitting data on a data channel; and
selecting the first transmission power for the user equipment to transmit the control channel in transmission time intervals in which the user equipment is not also transmitting data on the data channel.

2. The method according to claim 1, wherein the second transmission power is determined by the user equipment autonomously applying a step adjustment to the first transmission power, where the step adjustment is outside the closed loop power control.

3. The method according to claim 2, wherein:
the first transmission power is P_{tx,DPCCH}=P_{tx,DPCCH}_{_{—}}_{old} Δ_{PC}, where P_{tx,DPCCH}_{_{—}}_{old} is the user equipment's transmission power for the control channel in a previous slot and Apc is a power control step received from the wireless network;
the second transmission power is P_{tx,DPCCH}=P_{tx,DPCCH}_{_{—}}_{old}+Δ_{PC}+Δ_{TDM}, where the step adjustment is Δ_{TDM} and a sign of the step adjustment Δ_{TDM} is given by sign(P_{prev-grant}−P_{current-grant}) in which P_{prev-grant} and P_{current-grant} are transmission powers granted to the user equipment for the data channel in a previous and in a current slot respectively;
a magnitude of the step adjustment Δ_{TDM} is predefined in a radio standard or in wireless signaling received from the wireless network; and
applying the step adjustment is contingent on |P_{prev-grant}−P_{current-grant}| being greater than a predefined threshold α.

4. The method according to claim 1, wherein:
the first transmission power is P_{tx,DPCCH,own}_{_{—}}ₜᵣₐₙₛₘᵢₛₛᵢₒₙ=P_{tx,DPCCH}_{_{—}}_{old,own}_{_{—}}ₜᵣₐₙₛₘᵢₛₛᵢₒₙ+Δ_{PC,own}_{_{—}}ₜᵣₐₙₛₘᵢₛₛᵢₒₙ; and
the second transmission power is P_{tx,DPCCH,others}_{_{—}}ₜᵣₐₙₛₘᵢₛₛᵢₒₙ P_{tx,DPCCH}_{_{—}}_{old,others}_{_{—}}ₜᵣₐₙₛₘᵢₛₛᵢₒₙ+Δ_{PC,others}_{_{—}}ₜᵣₐₙₛₘᵢₛₛᵢₒₙ;
wherein:
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot where the user equipment is and is not also transmitting data on the data channel, respectively;
P_{tx,DPCCH}_{_{—}}_{old,own}_{_{—}}ₜᵣₐₙₛₘᵢₛₛᵢₒₙ is transmission power of the control channel in a previous slot belonging to a transmission time interval in which the user equipment was also transmitting data on the data channel;
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel;
Δ_{PC,own}_{_{—}}ₜᵣₐₙₛₘᵢₛₛᵢₒₙ and Δ_{PC,others}_{_{—}}ₜᵣₐₙₛₘᵢₛₛᵢₒₙ are power control steps received from the wireless network corresponding to slots where the user equipment is and is not also transmitting data on the data channel, respectively.

5. The method according to claim 1, wherein the second transmission power for the control channel is determined by applying a delta value to the first transmission power.

6. The method according to claim 5, wherein:
the first transmission power is P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC}, and
the second transmission power is P_{tx,DPCCH,own}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ−Δ_{own}_{_{—}}ₜᵣₐₙₛₘᵢₛₛᵢₒₙ+Δ_{PC},
where
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot,
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel, and
Δ_{own}_{_{—}}ₜᵣₐₙₛₘᵢₛₛᵢₒₙ is the delta value.

7. The method according to claim 5, wherein the delta value is determined by the user equipment using transmission power control commands that are received from the network as part of the closed loop power control for transmission time intervals in which the user equipment is also transmitting data on the data channel.

8. The method according to claim 1, wherein the method is contingent upon the user equipment receiving an explicit indication from the wireless network that time division multiplexing is currently in use for scheduling the user equipment.

9. An apparatus for operating a user equipment, the apparatus comprising:
at least one processor; and
at least one memory storing a computer program;
wherein the at least one processor is configured with the at least one memory and the computer program to cause the user equipment to at least:
determine a first transmission power for a control channel using closed loop power control with a wireless network;
determine a second transmission power for the control channel;
select the second transmission power for the user equipment to transmit the control channel in transmission time intervals in which the user equipment is also transmitting data on a data channel; and
select the first transmission power for the user equipment to transmit the control channel in transmission time intervals in which the user equipment is not also transmitting data on the data channel.

10. The apparatus according to claim 9, wherein the second transmission power is determined by the user equipment autonomously applying a step adjustment to the first transmission power, where the step adjustment is outside the closed loop power control.

11. The apparatus according to claim 10, wherein:
the first transmission power is P_{tx,DPCCH}=P_{tx,DPCCH}_{_{—}}_{old}+Δ_{PC}, where P_{tx,DPCCH}_{_{—}}_{old} is the user equipment's transmission power for the control channel in a previous slot and Apc is a power control step received from the wireless network;
the second transmission power is P_{tx,DPCCH}=P_{tx,DPCCH}_{_{—}}_{old}+Δ_{PC}+Δ_{TDM}, where the step adjustment is Δ_{TDM} and a sign of the step adjustment Δ_{TDM} is given by sign(P_{prev-grant}−P_{current-grant}) in which P_{prev-grant} and P_{current-grant} are transmission powers granted to the user equipment for the data channel in a previous and in a current slot respectively;
a magnitude of the step adjustment Δ_{TDM} is predefined in a radio standard or in wireless signaling received from the wireless network; and
applying the step adjustment is contingent on |P_{prev-grant}−P_{current-grant}| being greater than a predefined threshold α.

12. The apparatus according to claim 9, wherein:
the first transmission power is P_{tx,DPCCH,own}_{_{—}}ₜᵣₐₙₛₘᵢₛₛᵢₒₙ=P_{tx,DPCCH}_{_{—}}_{old,own}_{_{—}}ₜᵣₐₙₛₘᵢₛₛᵢₒₙ Δ_{PC,own}_{_{—}}ₜᵣₐₙₛₘᵢₛₛᵢₒₙ; and
the second transmission power P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC,others}_{_{—}}ₜᵣₐₙₛₘᵢₛₛᵢₒₙ;
wherein:
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot where the user equipment is and is not also transmitting data on the data channel, respectively;
P_{tx,DPCCH}_{_{—}}_{old,own}_{_{—}}ₜᵣₐₙₛₘᵢₛₛᵢₒₙ is transmission power of the control channel in a previous slot belonging to a transmission time interval in which the user equipment was also transmitting data on the data channel;
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel;
Δ_{PC,own}_{_{—}}ₜᵣₐₙₛₘᵢₛₛᵢₒₙ and Δ_{PC,others}_{_{—}}ₜᵣₐₙₛₘᵢₛₛᵢₒₙ are power control steps received from the wireless network corresponding to slots where the user equipment is and is not also transmitting data on the data channel, respectively.

13. The apparatus according to claim 9, wherein the second transmission power for the control channel is determined by applying a delta value to the first transmission power.

14. The apparatus according to claim 13, wherein:
the first transmission power is P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{pc}, and
the second transmission power is P_{tx,DPCCH,own}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ−Δ_{own}_{_{—}}ₜᵣₐₙₛₘᵢₛₛᵢₒₙ+Δ_{PC},
where
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot,
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel, and
Δ_{own}_{_{—}}ₜᵣₐₙₛₘᵢₛₛᵢₒₙ is the delta value.

15. The apparatus according to claim 13, wherein the delta value is determined by the user equipment using transmission power control commands that are received from the network as part of the closed loop power control for transmission time intervals in which the user equipment is also transmitting data on the data channel.

16. The apparatus according to claim 9, wherein execution of the computer program to cause the apparatus to determine and select according to claim 9 is contingent upon the user equipment receiving an explicit indication from the wireless network that time division multiplexing is currently in use for scheduling the user equipment.

17. A computer readable memory storing a computer program for operating a user equipment, wherein the computer program is executable by at least one processor and comprises:
code for determining a first transmission power for a control channel using closed loop power control with a wireless network;
code for determining a second transmission power for the control channel;
code for selecting the second transmission power for the user equipment to transmit the control channel in transmission time intervals in which the user equipment is also transmitting data on a data channel; and
code for selecting the first transmission power for the user equipment to transmit the control channel in transmission time intervals in which the user equipment is not also transmitting data on the data channel.

18. The computer readable memory according to claim 17, wherein:
the first transmission power is P_{tx,DPCCH}=P_{tx,DPCCH}_{_{—}}_{old}+Δ_{PC}, where P_{tx,DPCCH}_{_{—}}_{old} is the user equipment's transmission power for the control channel in a previous slot and Δ_{PC} is a power control step received from the wireless network;
the second transmission power is P_{tx,DPCCH}=P_{tx,DPCCH}_{_{—}}_{old}+Δ_{PC}+Δ_{TDM}, where Δ_{TDM} is a step adjustment autonomously applied by the user equipment and a sign of the step adjustment Δ_{TDM} is given by sign(P_{prev-grant}−P_{current-grant}) in which P_{prev-grant} and P_{current-grant} are transmission powers granted to the user equipment for the data channel in a previous and in a current slot respectively;
a magnitude of the step adjustment Δ_{TDM} is predefined in a radio standard or in wireless signaling received from the wireless network; and
applying the step adjustment is contingent on |P_{prev-grant}−P_{current-grant}| being greater than a predefined threshold α.

19. The computer readable memory according to claim 17, wherein:
the first transmission power is P_{tx,DPCCH,own}_{_{—}}ₜᵣₐₙₛₘᵢₛₛᵢₒₙ=P_{tx,DPCCH}_{_{—}}_{old,own}_{_{—}}ₜᵣₐₙₛₘᵢₛₛᵢₒₙ+Δ_{PC,own}_{_{—}}ₜᵣₐₙₛₘᵢₛₛᵢₒₙ; and
the second transmission power is P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC,others}_{_{—}}ₜᵣₐₙₛₘᵢₛₛᵢₒₙ;
wherein:
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot where the user equipment is and is not also transmitting data on the data channel, respectively;
P_{tx,DPCCH}_{_{—}}_{old,own}_{_{—}}ₜᵣₐₙₛₘᵢₛₛᵢₒₙ is transmission power of the control channel in a previous slot belonging to a transmission time interval in which the user equipment was also transmitting data on the data channel;
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel;
Δ_{PC,own}_{_{—}}ₜᵣₐₙₛₘᵢₛₛᵢₒₙ and Δ_{PC,others}_{_{—}}ₜᵣₐₙₛₘᵢₛₛᵢₒₙ are power control steps received from the wireless network corresponding to slots where the user equipment is and is not also transmitting data on the data channel, respectively.

20. The computer readable memory according to claim 17, wherein:
the first transmission power is P_{tx,DPCCH,others}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ+Δ_{PC}, and
the second transmission power is P_{tx,DPCCH,own}_{_{—}}ₜᵣₐₙₛₘᵢₛₛᵢₒₙ=P_{tx,DPCCH}_{_{—}}_{old,others}_{_{—}}ₜᵣₐₙₛₘᵢₛₛᵢₒₙ−Δ_{own}_{_{—}}ₜᵣₐₙₛₘᵢₛₛᵢₒₙ+Δ_{PC},
where
P_{tx,DPCCH,own}_{_{—}}ₜᵣₐₙₛₘᵢₛₛᵢₒₙ and P_{tx,DPCCH,other}_{_{—}}ₜᵣₐₙₛₘᵢₛₛᵢₒₙ are transmission powers of the control channel for a current slot,
P_{tx,DPCCH}_{_{—}}_{old,others}_{_{—}}ₜᵣₐₙₛₘᵢₛₛᵢₒₙ is transmission power of the control channel in a previous slot belonging to a transmission time interval in which the user equipment was not also transmitting data on the data channel, and
Δ_{own}_{_{—}}ₜᵣₐₙₛₘᵢₛₛᵢₒₙ is a delta value.
